(19) United States
(12) Patent Application Publication
(10) Pub. No.: US 2020/0109799 A1
(43) Pub. Date: Apr. 9, 2020

(54) QUICK CONNECTOR

(71) Applicant: MODERNSOLID INDUSTRIAL CO., LTD., Taichung City (TW)

(72) Inventor: Chin-Jui Hung, Taichung City (TW)

(21) Appl. No.: 16/578,940

(22) Filed: Sep. 23, 2019

(30) Foreign Application Priority Data
Oct. 8, 2018 (TW) 107135366

(51) Int. Cl. F16L 3/22; F16M 13/02

(52) U.S. Cl. CPC F16L 3/22; F16M 11/041; F16M 13/022

(57) ABSTRACT

A quick connector for being separably mounted to an object includes a holding member, a connecting member and an operating member. The holding member defines a holding space permitting the object to extend therethrough, and has two driven end portions. The connecting member is pivoted to one of the driven end portions at a first pivot point. The operating member is pivoted to the other one of the driven end portions at a second pivot point, and is pivoted to the connecting member at a third pivot point. The quick connector is operable to switch between a released state and a holding state.

### CROSS-REFERENCE TO RELATED APPLICATION

This application claims priority of Taiwanese Invention Patent Application No. 107135366, filed on Oct. 8, 2018.

### FIELD

The disclosure relates to a connector, and more particularly to a quick connector.

### BACKGROUND

Referring to FIG. 1, a conventional monitor support device 1 includes a post 11, two connecting members 12 that are movably sleeved on the post 11, and two arms 13. Each of the connecting members 12 has an extension portion 121, two holding portions 122 that cooperatively define a holding space 120 therebetween through which the post 11 extends, and a screw 123 that is mounted to the holding portions 122 and that is operable to adjust the dimension of the holding space 120. Each of the arms 13 is connected to the extension portion 121 of a respective one of the connecting members 12, and is for supporting a monitor 2. For each of the connecting members 12, by turning the screw 123 relative to the holding portions 122, the holding space 120 can be enlarged or shrunken so that the connecting member 12 may be movable along the post 11 or be secured on the post 11 for positioning the corresponding monitor 2 relative to the post 11 at a desired position.

However, the screw 123 of each of the connecting members 12 needs to be operated using a hand tool such as a screwdriver or a wrench, rendering adjustment of the connecting member 12 inconvenient. Moreover, each connecting member 12 cannot be mounted with multiple arms 13.

### SUMMARY

Therefore, an object of the disclosure is to provide a quick connector that can alleviate at least one of the drawbacks of the prior art.

According to the disclosure, the quick connector is for being separably mounted to a first object, and includes a holding member, a connecting member and an operating member. The holding member extends around an axial line to define a holding space that is adapted to permit the first object to extend therethrough, and has two driven end portions. The connecting member has a first end portion that is pivoted to one of the driven end portions of the holding member at a first pivot point, and a second end portion that is opposite to the first end portion. The operating member has a pivot end portion that is pivoted to the other one of the driven end portions of the holding member at a second pivot point, and an operating end portion that is opposite to the pivot end portion and that is pivoted to the second end portion of the connecting member at a third pivot point. The quick connector is operable to switch between a released state in which the operating end portion is spaced apart from the holding member, and a holding state in which the operating end portion abuts against the holding member. The third pivot point moves from one of two opposite sides of an imaginary line that passes through the first and second pivot point to the other one of the opposite sides of the imaginary line during conversion of the quick connector from one of the released state and the holding state to the other one of the released state and the holding state.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a conventional monitor support device;

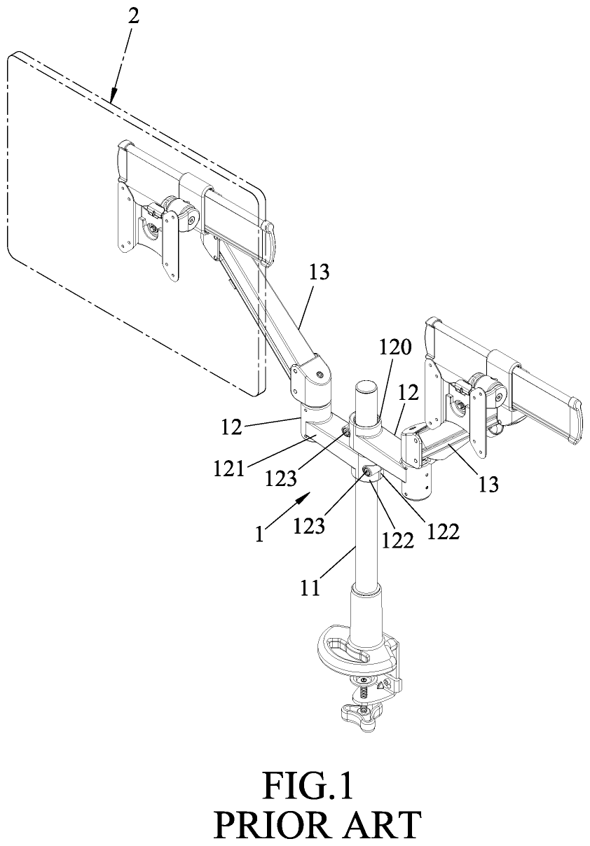

FIG. 2 is an exploded perspective view illustrating a first embodiment of a quick connector according to the disclosure;

FIG. 3 is a perspective view illustrating the first embodiment;

FIG. 4 is another perspective view illustrating the first embodiment;

FIG. 5 is a schematic view illustrating the first embodiment interconnecting a first extending member and two second extending members;

FIG. 6 is a sectional view taken along line XI-XI in FIG. 3, illustrating the first embodiment mounted to the first extending member;

FIG. 7 is a sectional view taken along line VII-VII in FIG. 5, illustrating the first embodiment in a holding state;

FIG. 8 is a view similar to FIG. 7, illustrating the first embodiment in a released state;

FIG. 9 is a view similar to FIG. 7, illustrating the first embodiment in a transition state;

FIG. 10 is a sectional view illustrating a modification of the first embodiment; and

FIG. 11 is a top view illustrating a second embodiment of the quick connector according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

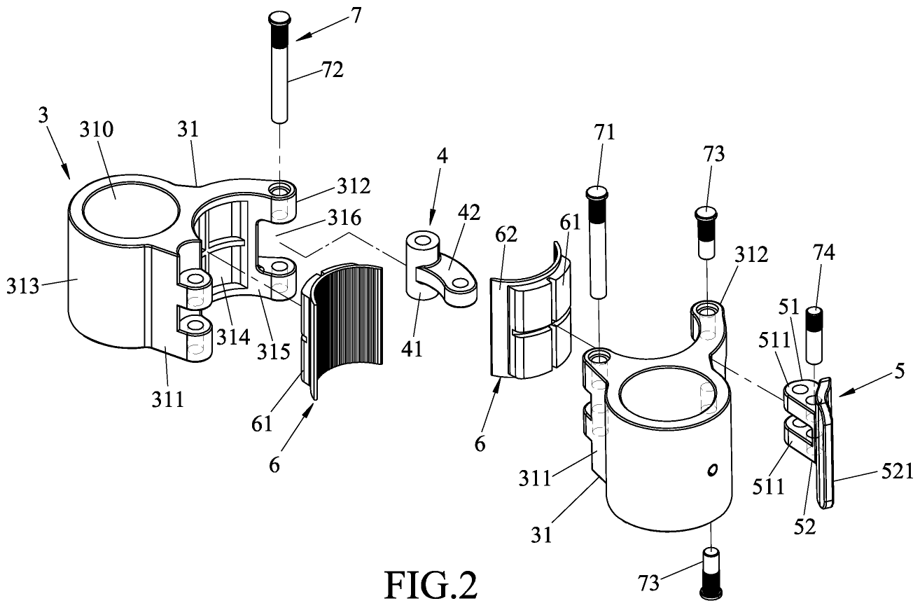

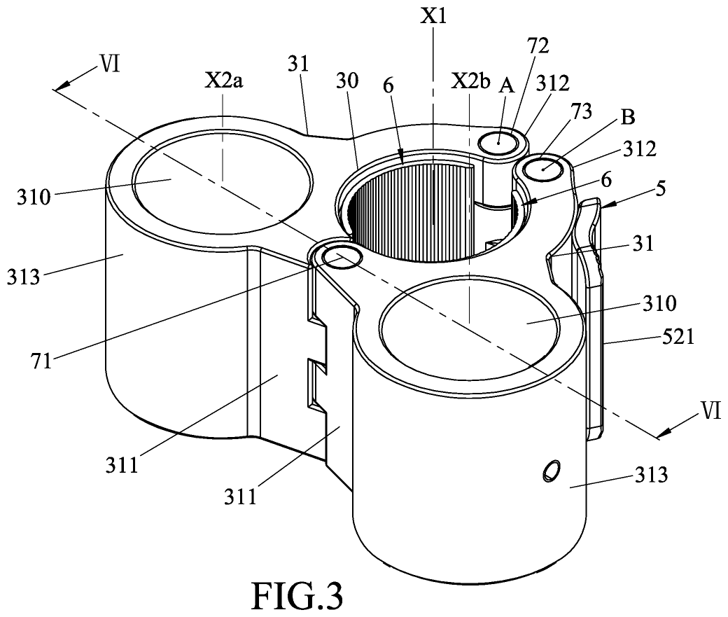

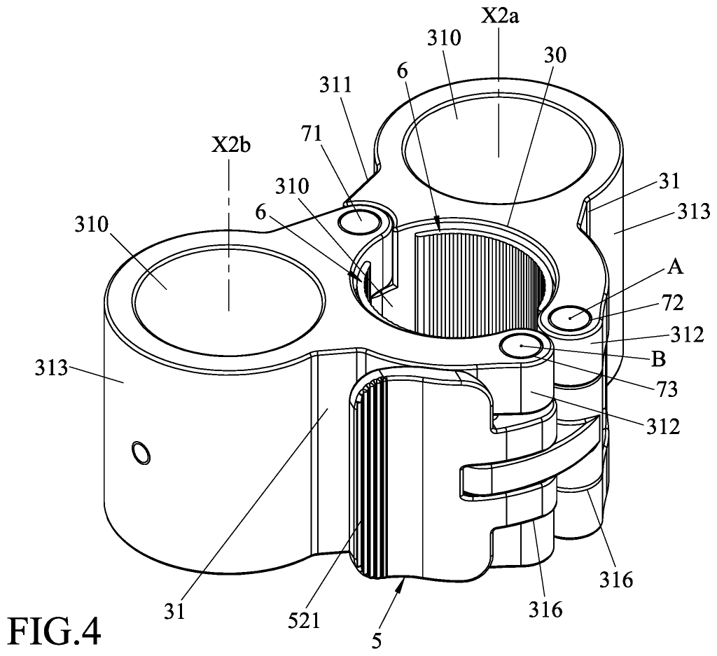

Referring to FIGS. 2 to 4, the first embodiment of the quick connector according to the disclosure includes a holding member 3, a connecting member 4, an operating member 5, two cushion pads 6 and a pivot unit 7.

The holding member 3 includes two holding arms 31 that cooperatively define a holding space 30 therebetween and that extend around an axial line (X1). Each of the holding arms 31 has a connecting end portion 311, a driven end portion 312 that is opposite to the connecting end portion 311, a seat portion 313 that surrounds a central line (X2a, X2b) to define a mounting hole 310, and an inner surface 315 that faces the holding space 30 and that is formed with a plurality of recesses 314. The driven end portion 312 of each of the holding arms 31 is formed with a breach 316. The connecting end portions 311 of the holding arms 31 are pivoted to each other.

The connecting member 4 has a first end portion 41, and a second end portion 42 opposite to the first end portion 41. The first end portion 41 of the connecting member 4 is mounted to the breach 316 of one of the holding arms 31, and is pivotable relative to the driven end portion 312 of the one of the holding arms 31 about a first pivot point (A).

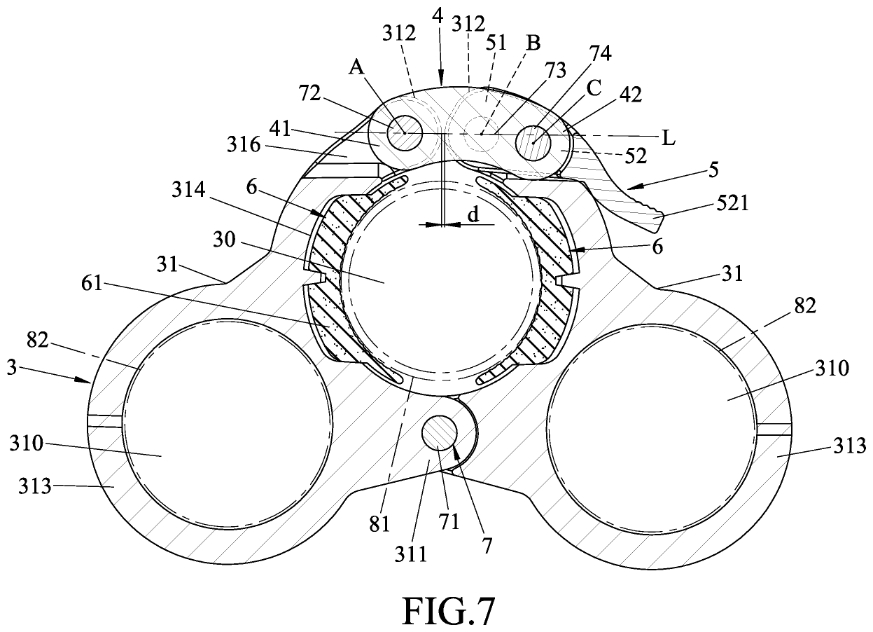

The operating member 5 has a pivot end portion 51, and an operating end portion 52 that is opposite to the pivot end portion 51. The pivot end portion 51 of the operating member 5 is mounted to the breach 316 of the other one of the holding arms 31, and is pivotable relative to the driven end portion 312 of the other one of the holding arms 31 about a second pivot point (B). The second end portion 42 of the connecting member 4 and the operating end portion 52 of the operating member 5 are pivotable relative to each other about a third pivot point (C) (see FIGS. 7 to 9). The operating end portion 52 has an extension 521. In some embodiment, the operating member 5 has two spaced apart lugs 511 each of which partially forms the pivot end portion 51 and partially forms the operating end portion 52. The lugs 511 permit the second end portion 42 of the connecting member 4 to extend therebetween.

Referring to FIGS. 2 and 7, the cushion pads 6 are respectively mounted to the inner surfaces 315 of the holding arms 31. Each of the cushion pads 6 has an outer surface 62 that is formed with a plurality of protrusions 61 engaging the recesses 314 of the corresponding one of the holding arms 31. It should be noted that, in some embodiment, there may be only one cushion pad 6.

The pivot unit 7 includes a first pivot member 71 that pivotally interconnects the connecting end portions 311 of the holding arms 31, a second pivot member 72 that pivotally interconnects the first end portion 41 of the connecting member 4 and the driven end portion 312 of the one of the holding arms 31 and that forms the first pivot point (A), two third pivot members 73 that pivotally interconnects the pivot end portion 51 of the operating member 5 and the driven end portion 312 of the other one of the holding arms 31 and that form the second pivot point (B), and a fourth pivot member 74 that pivotally interconnects the second end portion 42 of the connecting member 4 and the operating end portion 52 of the operating member 5 and that forms the third pivot point (C).

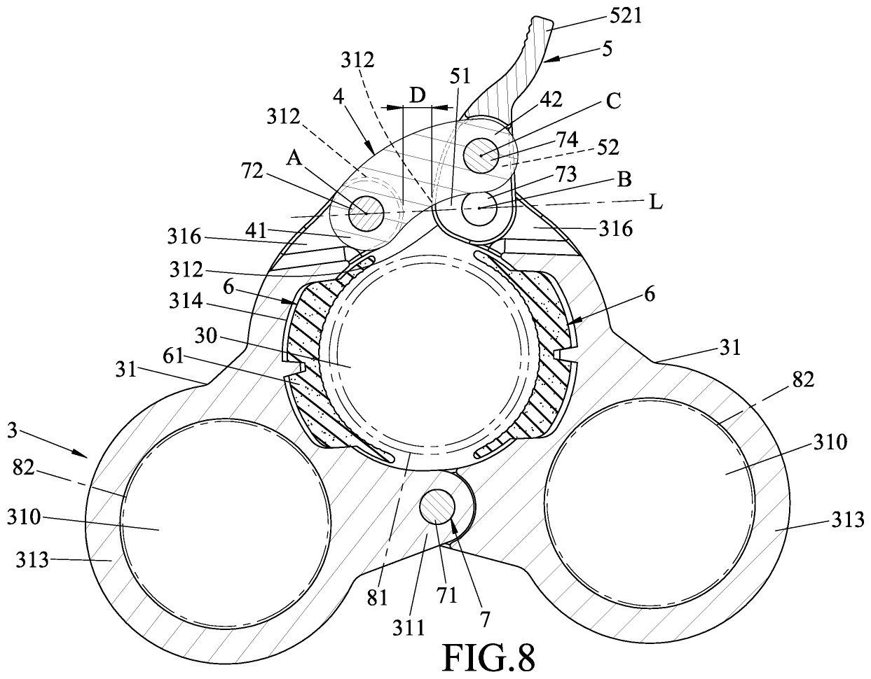

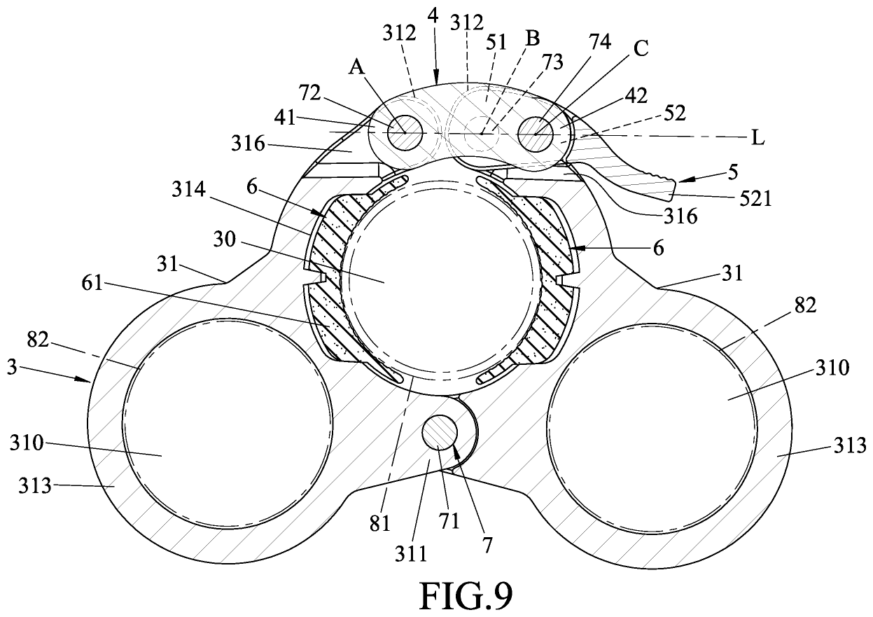

The quick connector according to the disclosure is operable to switch among a holding state (see FIG. 7), a released state (see FIG. 8) and a transition state (see FIG. 9). Referring to FIG. 8, when the quick connector is in the released state, the driven end portions 312 of the holding member 3 are spaced apart from each other by a released distance (D), the third pivot point (C) and a major portion of the holding member 3 are respectively located at two opposite sides of an imaginary line (L) that passes through the first and second pivot points (A, B), and the extension 521 of the operating member 5 is spaced apart from the holding member 3. Referring to FIG. 7, when the quick connector is in the holding state, the driven end portions 312 of the holding member 3 are spaced apart from each other by a holding distance (d) smaller than the released distance (D), the third pivot point (C) and the major portion of the holding member 3 are located at the same side of the imaginary line (L), and the extension 521 of the operating member 5 abuts against the holding member 3. Referring to FIG. 9, when the quick connector is in the transition state (transiently), the third pivot point (C) is located on the imaginary line (L), and the driven end portions 312 of the holding member 3 are closest to each other. In some embodiment, when the quick connector is in the holding state, the connecting member 4 and the operating member 5 extend along an arc that extends around the axial line (X1). In some embodiment, the path of movement of the third pivot point (C) is configured not to pass through a space between the first and second pivot point (A, B).

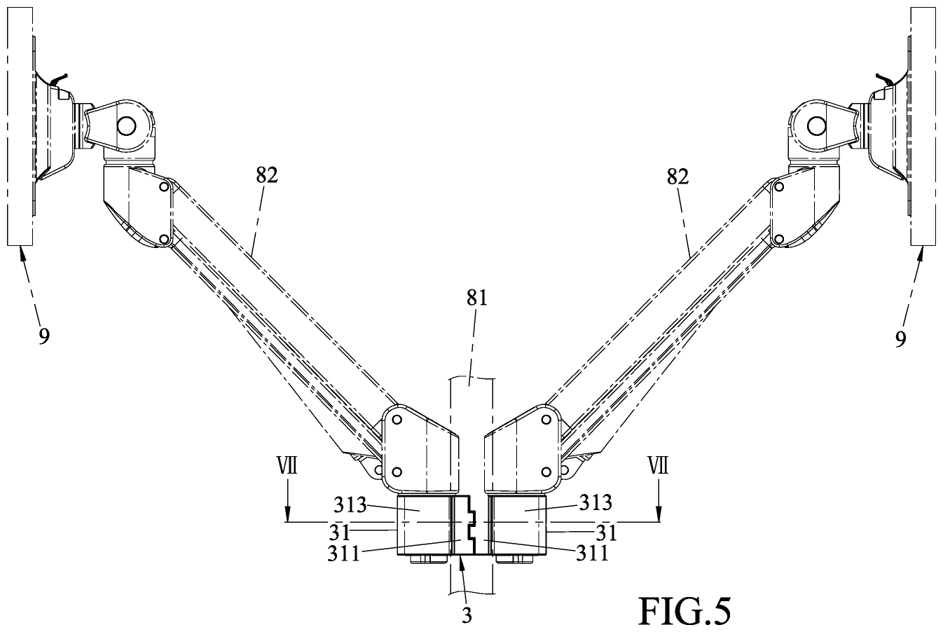

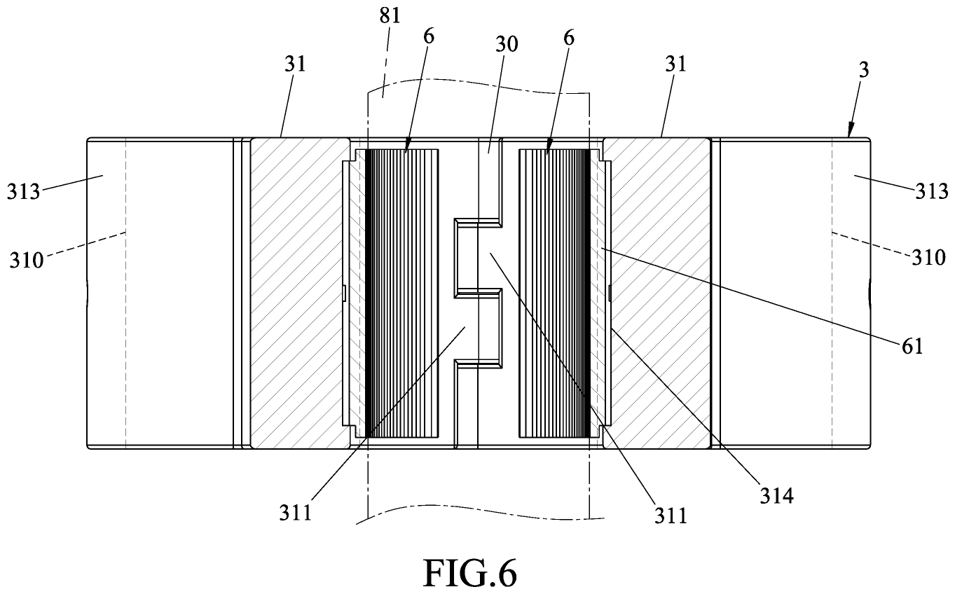

Referring to FIGS. 5 and 6, the quick connector according to the disclosure is adapted for interconnecting a first extending member 81 and two second extending members 82. The first extending member 81 may be configured as a post that extends along the axial line (X1). Each of the second extending members 82 may be configured as a support arm that supports a monitor 9 and that is mounted to a respective one of the mounting holes 310 of the holding member 3.

To mount the quick connector onto the first extending member 81, the quick connector is first switched into the released state and sleeved on the first extending member 81, then the operating member 5 is operated to switch the quick connector into the holding state through the transition state so as to position the quick connector relative to the first extending member 81.

During the conversion from the released state to the transition state, the driven end portions 312 of the holding member 3 approach each other to shrink the holding space 30, so that friction is generated between the cushion pads 6 and the first extending member 81 and that the driven end portions 312 of the holding member 3 tend to move away from each other. When the third pivot point (C) moves past the imaginary line (L) to the side at which the major portion of the holding member 3 is located, the relative movement between the driven end portions 312 of the holding member 3 away from each other drives the extension 521 of the operating member 5 to move to abut against the holding member 3, so that the driven end portions 312 of the holding member 3 cannot move further away from each other, and that the quick connector is maintained in the holding state to be positioned relative to the first extending member 81.

To move the quick connector along the first extending member 81, the operating member 5 is operated to switch the quick connector into the released state so that the holding space 30 is enlarged and the friction generated between the cushion pads 6 and the first extending member 81 is diminished to permit relative movement between the quick connector and the first extending member 81.

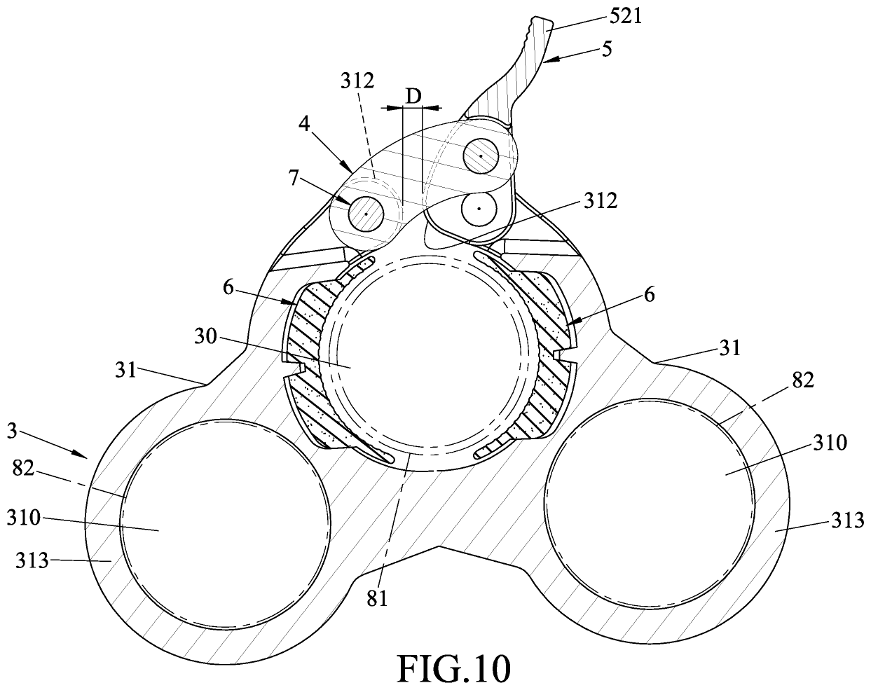

Referring to FIG. 10, the holding member 3 of a modification of the first embodiment has only one holding arm 31. The holding arm 31 is flexible and has the driven end portions 312. By operation of the operating member 5, the quick connector can also be switched among the released state, the transition state and the holding state, as the embodiment illustrated above, so as to be positioned relative to the first extending member 81 or to be permitted to move along the first extending member 81.

In some embodiment, the holding space 30 may be circular, elliptic, rectangular, polygonal, and so on.

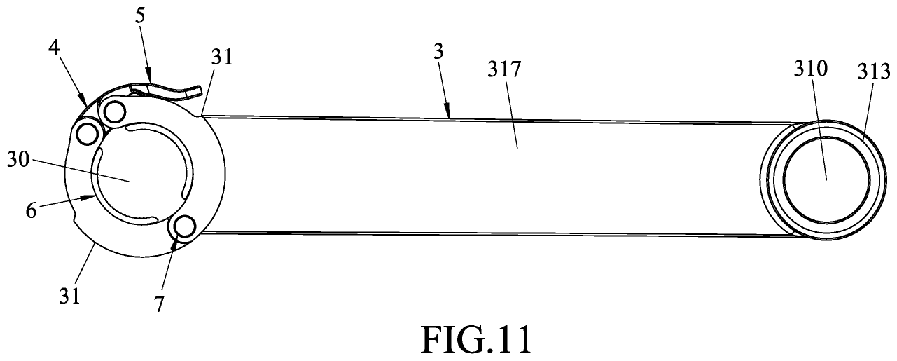

Referring to FIG. 11, the second embodiment of the quick connector according to the disclosure is similar to the first embodiment, and includes the holding member 3, the connecting member 4, the operating member 5, the cushion pads 6 and the pivot unit 7.

One of the holding arms 31 of the second embodiment further has an extending portion 317 that is connected to the seat portion 313. The operation of the second embodiment is the same as that of the first embodiment.

The advantages of the quick connector of the disclosure are as follows:

1. The quick connector is switched by operation of the operating member 5. There is no need for an additional hand tool.

2. By the variation of the location of the third pivot point (C), the quick connector can be maintained in the holding state.

3. The protrusions 61 of the cushion pad 6 facilitates positioning between the cushion pad 6 and the holding arm 31, and serves to increase the thickness of the cushion pad 6.

4. The holding member 3 may include multiple mounting holes 310 for being mounted with multiple support arms.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A quick connector adapted for being separably mounted to a first object, comprising:
a holding member extending around an axial line to define a holding space that is adapted to permit the first object to extend therethrough, and having two driven end portions;
a connecting member having a first end portion that is pivoted to one of said driven end portions of said holding member at a first pivot point, and a second end portion that is opposite to said first end portion; and
an operating member having a pivot end portion that is pivoted to the other one of said driven end portions of said holding member at a second pivot point, and an operating end portion that is opposite to said pivot end portion and that is pivoted to said second end portion of said connecting member at a third pivot point, said quick connector being operable to switch between a released state in which said operating end portion is spaced apart from said holding member, and a holding state in which said operating end portion abuts against said holding member, said third pivot point moving from one of two opposite sides of an imaginary line that passes through said first and second pivot point to the other one of the opposite sides of the imaginary line during conversion of said quick connector from one of the released state and the holding state to the other one of the released state and the holding state.

2. The quick connector as claimed in claim 1, wherein, during conversion of said quick connector between the released state and the holding state, said quick connector is transiently switched into a transition state in which: said third pivot point is located on the imaginary line; and said driven end portions are closest to each other.

3. The quick connector as claimed in claim 1, wherein when said quick connector is in the holding state, said connecting member and said operating member extend along an arc that extends around the axial line.

4. The quick connector as claimed in claim 1, wherein each of said driven end portions of said holding member is formed with a breach that permits a corresponding one of said first end portion of said connecting member and said pivot end portion of said operating member to be mounted thereto.

5. The quick connector as claimed in claim 4, wherein said operating member has two spaced apart lugs each of which partially forms said pivot end portion and partially forms said operating end portion, said lugs permitting said second end portion of said connecting member to extend therebetween.

6. The quick connector as claimed in claim 1, wherein said holding member includes two holding arms, each of said holding arms having one of said driven end portions and a connecting end portion that is opposite to said driven end portions, said connecting end portions of said holding arms being pivoted to each other.

7. The quick connector as claimed in claim 1, wherein said holding member further includes at least one seat portion that is adapted for being mounted with a second object.

8. The quick connector as claimed in claim 7, wherein said holding member includes two of said seat portions that are adapted for being respectively mounted with two second objects.

9. The quick connector as claimed in claim 7, wherein said at least one seat portion surrounds a central line to define a mounting hole.

10. The quick connector as claimed in claim 7, wherein said holding member further has an inner surface that faces said holding space and that is formed with a plurality of recesses, said quick connector further comprising at least one cushion pad that has an outer surface formed with a plurality of protrusions, said protrusions engaging said recesses of said holding member so that said at least one cushion pad is mounted to said inner surface of said holding member.
